(19) United States
(12) Patent Application Publication
(10) Pub. No.: US 2018/0220111 A1
(43) Pub. Date: Aug. 2, 2018

(54) PROJECTOR AND METHOD OF CONTROLLING PROJECTOR

(71) Applicant: SEIKO EPSON CORPORATION, Tokyo (JP)

(72) Inventor: Minoru YOKOBAYASHI, Matsumoto-Shi (JP)

(73) Assignee: SEIKO EPSON CORPORATION, Tokyo (JP)

(21) Appl. No.: 15/873,242

(22) Filed: Jan. 17, 2018

(30) Foreign Application Priority Data
Jan. 31, 2017 (JP) 2017-015644

(51) Int. Cl. H04N 9/31; G03B 21/43; G02F 1/1335; G09G 3/36; H04N 5/74

(52) U.S. Cl. CPC H04N 9/3179; G03B 21/43; H04N 9/3155; G09G 3/36; H04N 5/7416; G02F 1/1335

(57) ABSTRACT

A projector includes a plurality of light source sections, a light modulation device, and a drive section. The plurality of light source sections includes a first light source section and a second light source section different from each other in wavelength of emitted light. In a case of varying brightness of light emission of the first light source section and the second light source section, the drive section is configured to determine first light emission information with respect to light emission of the first light source section and second light emission information with respect to light emission of the second light source section, and then, at a predetermined timing, adjust the light emission of the first light source section based on the first light emission information and adjust the light emission of the second light source section based on the second light emission information.

### BACKGROUND

### 1. Technical Field

The present invention relates to a projector, and a method of controlling the projector.

### 2. Related Art

In the past, there has been known a projector for modulating light including red light (R light), green light (G light) and blue light (B light) emitted from a light source with a light modulation element such as a liquid crystal device or a DMD to thereby project image light (see, e.g., JP-A-2015-057671).

In this projector, there are provided a plurality of light sources respectively emitting the light of the colors of R, G, and B, a plurality of drive circuits for individually controlling the respective light sources, and a light intensity control section for controlling the drive circuits, and by the light intensity control section controlling the output of the light sources of the respective colors, desired white balance is realized. Further, the light intensity control section changes the brightness of each of the light sources in accordance with a video signal received by a video signal processing circuit.

However, in the related art described above, in the case in which the light intensity control section changes the brightness of each of the light source, the light intensity control section controls the output of the light source (brightness control) color by color. Therefore, there occurs a shift in control timing between the light sources, and there is a possibility of losing a color balance in the projection image.

### SUMMARY

An advantage of some aspects of the invention is to provide a projector and a method of controlling the projector capable of reducing disturbances in the color balance.

According to a first aspect of the invention, a projector is provided. The projector includes a plurality of light source sections configured to emit light respectively, a light modulation device configured to modulate the light emitted from the plurality of light source sections in accordance with image information, a projection optical system configured to project the light modulated by the light modulation device, and a drive section configured to drive the plurality of light source sections. The plurality of light source sections includes a first light source section and a second light source section different from each other in wavelength of the light emitted. In a case of varying brightness of light emission of the first light source section and the second light source section, the drive section is configured to determine first light emission information with respect to light emission of the first light source section and second light emission information with respect to light emission of the second light source section, and then, at a predetermined timing, adjust the light emission of the first light source section based on the first light emission information and adjust the light emission of the second light source section based on the second light emission information.

In the projector according to the first aspect of the invention, since the drive section switches the brightness of the first light source section and the brightness of the second light source section at once, the light control can be performed without causing the disturbance in the color balance.

In the first aspect of the invention described above, it is preferable that the drive section, at a timing at which a vertical sync signal is output to the light modulation device as the predetermined timing, adjusts the light emission of the first light source section based on the first light emission information and adjust the light emission of the second light source section based on the second light emission information.

According to this configuration, since the brightness of the first light source section and the brightness of the second light source section are switched in sync with the timing (i.e., an input timing of the vertical sync signal) for making the light modulation device display the image, it is possible to reduce the occurrence of the flickers in the projection image.

In the first aspect of the invention described above, it is preferable that the drive section drives the first light source section and the second light source section with pulse width modulation control of a drive current respectively supplied to the first light source section and the second light source section, and the first light emission information and the second light emission information each include at least one of a current value of the drive current and a pulse width of the pulse width modulation control.

According to this configuration, by using the information related to the current value of the drive current and the pulse width of the pulse width modulation control, it is possible to easily realize the brightness control of the first light source section and the second light source section described above.

In the first aspect of the invention described above, it is preferable that the first light source section includes a first light emitting element group configured to emit the light with a first wavelength, and the second light source section includes a second light emitting element group configured to emit the light with the first wavelength, and a light wavelength conversion element configured to convert a wavelength of the light emitted from the second light emitting element group from the first wavelength into a second wavelength different from the first wavelength.

According to this configuration, it is possible to realize the configuration of emitting the light with the second wavelength different from the first wavelength from the second light source section.

In the first aspect of the invention described above, it is preferable that the light with the first wavelength is light in a wavelength band of 430 nm through 480 nm, and the light with the second wavelength is light in a wavelength band of 520 nm through 580 nm.

According to this configuration, by converting the blue light as the light with the first wavelength using the wavelength conversion element, it is possible to generate yellow fluorescence as the light with the second wavelength.

In the first aspect of the invention described above, it is preferable that the first light source section includes a first light emitting element group configured to emit the light with a first wavelength, and the second light source section includes a third light emitting element group configured to emit the light with a third wavelength different from the first wavelength.

According to this configuration, it is possible to perform the light control without causing the disturbance in the color balance in the light with the first wavelength and the light with the third wavelength.

In the first aspect of the invention described above, it is preferable that the light with the first wavelength is light in one wavelength band of 430 nm through 480 nm, 480 nm through 520 nm, and 620 nm through 810 nm, and the light with the third wavelength is light in one wavelength band of remaining two wavelength bands.

According to this configuration, it is possible to perform the light control without causing the color balance of any two of red light, green light, and blue light emitted from the first light source section and the second light source section.

In the first aspect of the invention described above, it is preferable that the drive section is a single drive section, and the single drive section drives the first light source section and the second light source section different from each other in wavelength of the light emitted.

According to a second aspect of the invention, a method of controlling a projector is provided. The projector is provided with a plurality of light source sections including a first light source section and a second light source section different from each other in wavelength of light emitted, and a light modulation device configured to modulate the light from the plurality of light source sections in accordance with image information. The method includes obtaining information with respect to brightness of the image information, driving the plurality of light source sections based on the obtained information with respect to the brightness of the image information, and in a case of varying brightness of light emission of the first light source section and the second light source section, determining first light emission information with respect to light emission of the first light source section and second light emission information with respect to light emission of the second light source section, and then, at a predetermined timing, adjusting the light emission of the first light source section based on the first light emission information and adjusting the light emission of the second light source section based on the second light emission information.

In the method of controlling the projector according to the second aspect of the invention, since the brightness of the first light source section and the brightness of the second light source section are switched at once in the driving of the plurality of light source sections, the light control can be performed without causing the disturbance in the color balance.

### BRIEF DESCRIPTION OF THE DRAWINGS

The invention will be described with reference to the accompanying drawings, wherein like numbers reference like elements.

FIG. 1 is a schematic view showing an optical system of a projector.

FIG. 2 is a diagram showing a schematic configuration of an illumination device.

FIG. 3 is a timing chart for explaining the operation of the projector.

FIG. 4 is a diagram showing a projector according to a modified example.

### DESCRIPTION OF AN EXEMPLARY EMBODIMENT

An embodiment of the invention will hereinafter be described in detail with reference to the drawings.

It should be noted that the drawings used in the following description show characteristic parts in an enlarged manner in some cases for the sake of convenience in order to make the features easy to understand, and the dimensional ratios between the constituents and so on are not necessarily the same as actual ones.

An example of a projector according to the present embodiment will be described. The projector according to the present embodiment is a projection-type image display device for displaying a color picture on a screen (a projection target surface).

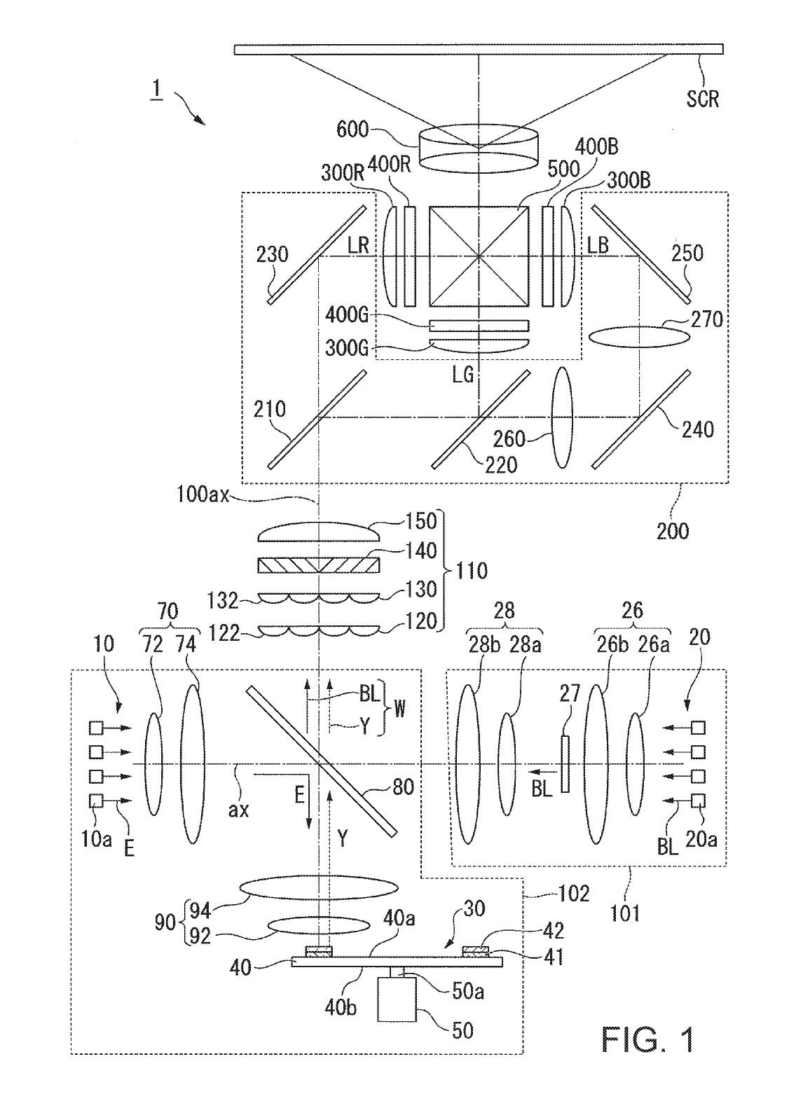

FIG. 1 is a top view showing an optical system of the projector 1 according to the present embodiment.

As shown in FIG. 1, the projector 1 is provided with a first light source section 101, a second light source section 102, a homogeneous illumination optical system 110, a color separation light guide optical system 200, liquid crystal light modulation devices 400R, 400G, and 400B corresponding respectively to the color light, namely red light, green light, and blue light, a cross dichroic prism 500, and a projection optical system 600.

The first light source section 101 is provided with a first light source 20, a light collection optical system 26, a scattering plate 27, and a collimating optical system 28.

The first light source 20 includes a plurality of semiconductor lasers (a first light emitting element group) 20a for emitting the blue light (the peak of the light emission intensity: e.g., 445 nm) BL, which is light with a first wavelength formed of a laser beam, as the image light.

It should be noted that the first light source 20 can also be a device formed of a single semiconductor laser 20a. Further, it is also possible for the first light source 20 to use a semiconductor laser 20a for emitting the blue light having a wavelength other than 445 nm. For example, the blue light BL is light in a wavelength band of 430 nm through 480 nm.

In the present embodiment, the first light source 20 is arranged to be able to control the luminance (brightness) by performing PWM (pulse width modulation) control on the semiconductor laser 20a. In the PWM control, by periodically putting on and off the semiconductor laser 20a, and varying the ratio (the duty ratio) between the lighting period and the extinction period, the luminance is controlled.

The light collection optical system 26 is provided with a first lens 26a and a second lens 26b. The light collection optical system 26 collects the blue light from the first light source 20 in the vicinity of the scattering plate 27. The first lens 26a and the second lens 26b are each formed of a convex lens.

The scattering plate 27 scatters blue light BL from the first light source 20 to thereby form the blue light BL having a light distribution similar to the light distribution of fluorescence Y emitted from a rotary fluorescent plate 30 described later. As the scattering plate 27, there can be used, for example, obscured glass made of optical glass.

The collimating optical system 28 is provided with a first lens 28a and a second lens 28b, and roughly collimates the light from the scattering plate 27. The first lens 28a and the second lens 28b are each formed of a convex lens.

The second light source section 102 is provided with a second light source 10, a collimating optical system 70, a dichroic mirror 80, a collimating light collection optical system 90 and the rotary fluorescent plate 30.

The second light source 10 includes a plurality of semiconductor lasers (a second light emitting element group) 10a for emitting blue light (the peak of the light emission intensity: e.g., 445 nm) E, which is light with the first wavelength formed of a laser beam, as the excitation light.

It should be noted that the second light source 10 can also be a device formed of a single semiconductor laser 10a. Further, it is also possible to use the semiconductor laser 10a for emitting the blue light having a wavelength (e.g., 430 nm through 480 nm) other than 445 nm as the second light source 10.

Similarly to the first light source 20, the luminance of the second light source 10 can be controlled by performing the PWM control on the semiconductor laser 10a.

In the present embodiment, the second light source 10 is arranged so as to have an optical axis ax perpendicular to the illumination light axis 100ax.

The collimating optical system 70 is provided with a first lens 72 and a second lens 74, and roughly collimates the light from the second light source 10. The first lens 72 and the second lens 74 are each formed of a convex lens.

The dichroic mirror 80 is disposed in a light path from the collimating optical system 70 to the collimating light collection optical system 90 so as to cross each of the optical axis ax of the second light source 10 and the illumination light axis 100ax at an angle of 45°. The dichroic mirror 80 reflects the blue light, and transmits yellow fluorescence including the red light and the green light.

The collimating light collection optical system 90 has a function of making the blue light E from the dichroic mirror 80 enter the phosphor element 42 of the rotary fluorescent plate 30 in a roughly focused state, and a function of roughly collimating the fluorescence emitted from the rotary fluorescent plate 30. The collimating light collection optical system 90 is provided with a first lens 92 and a second lens 94. The first lens 92 and the second lens 94 are each formed of a convex lens.

The rotary fluorescent plate 30 is provided with a motor 50, a circular disk 40, a reflecting film 41, and the phosphor element 42. The circular disk 40 can be rotated by the motor 50. The phosphor element 42 is disposed along the circumferential direction of the upper surface 40a of the circular disk 40 so as to have a roughly ring-like shape. The motor 50 is disposed on the lower surface 40b side of the circular disk 40, and the rotary shaft 50a of the motor 50 is attached to the circular disk 40.

The phosphor element 42 is a light wavelength conversion element for converting the blue light E (the light with the first wavelength) from the second light source 10 into the fluorescence Y (the light with the second wavelength). It should be noted that the fluorescence Y is the light in the wavelength band of, for example, 520 nm through 580 nm.

The surface of incidence of the blue light E of the phosphor element 42 is also an exit surface from which the fluorescence Y is emitted. The fluorescence Y is the yellow light including the red light and the green light. On the surface of the phosphor element 42, there is disposed an antireflection film (not shown) for preventing the reflection of the blue light E on the surface of the phosphor element 42.

In the present embodiment, since the blue light E formed of a laser beam enters the phosphor element 42, heat is generated in the phosphor element 42. In the present embodiment, the circular disk 40 is rotated to thereby sequentially change the incident position of the blue light E in the phosphor element 42. Thus, such a problem that the same part of the phosphor layer 42 is intensively irradiated with the blue light BL to thereby be deteriorated is prevented from occurring.

In the present embodiment, the ceramic fluorescent layer, for example, is used as the phosphor element 42 to thereby prevent the rise in temperature of the phosphor element 42 to prevent the light emission failure called temperature quenching from occurring. The phosphor element 42 is formed of, for example, (Y, Gd)₃(Al, Ga)₅O₁₂:Ce as a YAG phosphor material in a bulk form (massive form). Thus, it is possible to obtain a highlight emission efficiency of the fluorescence Y.

In the present embodiment, the blue light BL from the first light source 20 is reflected by the dichroic mirror 80, then combined with the fluorescence Y, which has been emitted from the rotary fluorescent plate 30 and then transmitted through the dichroic mirror 80, and then turns to white light W. The white light W enters the homogeneous illumination optical system 110.

Therefore, in the present embodiment, the first light source section 101 emits the blue light BL with the first wavelength, and the second light source section 102 emits the fluorescence Y with the second wavelength. Therefore, the wavelength of the light emitted by the first light source section 101 and the wavelength of the light emitted by the second light source section 102 are different from each other.

The homogeneous illumination optical system 110 is provided with a first lens array 120, a second lens array 130, a polarization conversion element 140, and an overlapping lens 150.

The first lens array 120 has a plurality of first small lenses 122 for dividing the light from the dichroic mirror 80 into a plurality of partial light fluxes. The plurality of first small lenses 122 is arranged in a matrix in a plane perpendicular to the illumination optical axis 100ax.

The second lens array 130 has a plurality of second small lenses 132 corresponding to the plurality of first small lenses 122 of the first lens array 120. The second lens array 130 images the image of each of the first small lenses 122 of the first lens array 120 in the vicinity of each of the image forming areas of the liquid crystal light modulation devices 400R, 400G, and 400B in cooperation with the overlapping lens 150. The plurality of second small lenses 132 is arranged in a matrix in a plane perpendicular to the illumination optical axis 100ax.

The polarization conversion element 140 converts each of the partial light fluxes, which are divided into by the first lens array 120, into a linearly-polarized light. The polarization conversion element 140 has a polarization separation layer, a reflecting layer, and a wave plate. The polarization separation layer transmits one linearly-polarized component without modification and reflects the other linearly-polarized component toward the reflecting layer out of the polarization components included in the light from the rotary fluorescent plate 30.

The reflecting layer reflects the other linearly-polarized component, which has been reflected by the polarization separation layer, in a direction parallel to the illumination light axis 100ax. The wave plate converts the other linearly-polarized component having been reflected by the reflecting layer into the one linearly-polarized component.

The overlapping lens 150 collects the partial light fluxes from the polarization conversion element 140 to overlap the partial light fluxes with each other in the vicinity of each of the image forming areas of the liquid crystal light modulation devices 400R, 400G, and 400B. The first lens array 120, the second lens array 130, and the overlapping lens 150 constitute an integrator optical system for homogenizing the in-plane light intensity distribution of the light from the rotary fluorescent plate 30.

The color separation light guide optical system 200 is provided with dichroic mirrors 210, 220, reflecting mirrors 230, 240, and 250, and relay lenses 260, 270. The color separation light guide optical system 200 separates the white light W, which has been emitted from the first light source section 101 and the second light source section 102 via the homogenous illumination optical system 110, into the red light LR, green light LG, and blue light LB, and guides the red light LR, the green light LG, and the blue light LB to the corresponding liquid crystal light modulation devices 400R, 400G, and 400B, respectively. Between the color separation light guide optical system 200 and the liquid crystal light modulation devices 400R, 400G, and 400B, there are disposed field lenses 300R, 300G, and 300B, respectively.

It should be noted that in the present embodiment, the red light LR corresponds to the light in the wavelength band of 620 nm through 810 nm, the green light LG corresponds to the light in the wavelength band of 480 nm through 520 nm, and the blue light LB corresponds to the light of 430 nm through 480 nm.

The dichroic mirror 210 is a dichroic mirror for transmitting the red light component and reflecting the green light component and the blue light component.

The dichroic mirror 220 is a dichroic mirror for reflecting the green light component and transmitting the blue light component.

The reflecting mirror 230 is a reflecting mirror for reflecting the red light component.

The reflecting mirrors 240, 250 are reflecting mirrors for reflecting the blue light component.

The red light having passed through the dichroic mirror 210 is reflected by the reflecting mirror 230, then passes through the field lens 300R, and then enters the image forming area of the liquid crystal light modulation device 400R for the red light.

The green light having been reflected by the dichroic mirror 210 is further reflected by the dichroic mirror 220, then passes through the field lens 300G, and then enters the image forming area of the liquid crystal light modulation device 400G for the green light.

The blue light having passed through the dichroic mirror 220 enters the image forming area of the liquid crystal light modulation device 400B for the blue light via the relay lens 260, the reflecting mirror 240 on the incident side, the relay lens 270, the reflecting mirror 250 on the exit side, and the field lens 300B.

The liquid crystal light modulation devices 400R, 400G, and 400B are each for modulating the incident color light in accordance with the image information to thereby form an image corresponding to the color light. It should be noted that, although not shown in the drawings, incident side polarization plates are disposed between the field lenses 300R, 300G, 300B and the liquid crystal light modulation devices 400R, 400G, 400B, respectively, and exit side polarization plates are disposed between the liquid crystal light modulation devices 400R, 400G, 400B and the cross dichroic prism 500, respectively.

The cross dichroic prism 500 is an optical element for combining the image light emitted from the respective liquid crystal light modulation devices 400R, 400G, 400B with each other to form the color image.

The cross dichroic prism 500 has a roughly rectangular planar shape composed of four rectangular prisms bonded to each other, and on the roughly X-shaped interfaces on which the rectangular prisms are bonded to each other, there are formed dielectric multilayer films.

The color image emitted from the cross dichroic prism 500 is projected in an enlarged manner by the projection optical system 600 to form an image on a screen SCR. In other words, the projection optical system 600 projects the light modulated by the respective liquid crystal light modulation devices 400R, 400G, and 400B on the screen SCR.

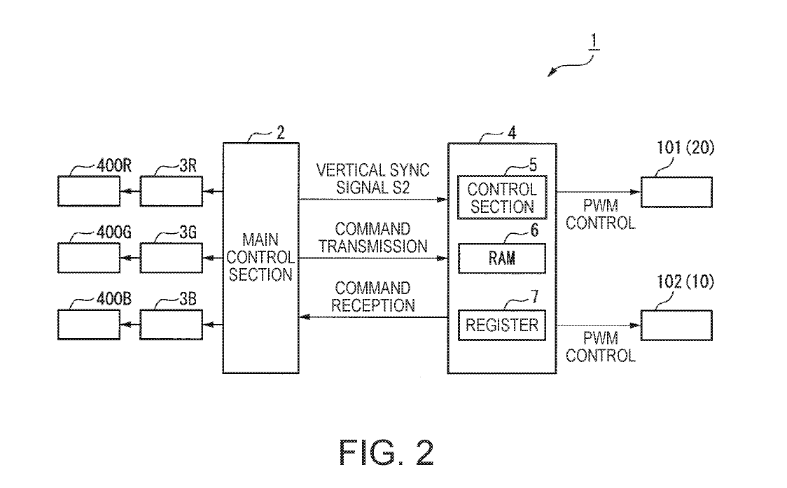

Next, an electrical configuration of the projector 1 will be described. FIG. 2 is a block diagram showing the electrical configuration of the projector 1.

As shown in FIG. 2, the projector 1 is provided with a main control section 2, display drivers 3R, 3G, and 3B, and a light source driver 4. The light source driver 4 corresponds to a “drive section” described in the appended claims.

The main control section 2 controls the display drivers 3R, 3G, and 3B, the light source driver 4, and each section of the projector 1. The main control section 2 is constituted by, for example, a central processing unit (CPU), a circuit for converting the video signal (the image information) input from the outside via an interface not shown into the video signal for the display drivers 3R, 3G, and 3B to generate the respective images, and a circuit for performing a process such as a gamma correction on the video signal. It should be noted that the video signal can also be stored in a storage section not shown provided to the projector 1. The video signal is a luminance-color difference signal, an analog RGB signal, or the like. The main control section 2 outputs the video signal input thereto to the display drivers 3R, 3G, and 3B.

The display drivers 3R, 3G, and 3B respectively drive the respective liquid crystal light modulation devices 400R, 400G, and 400B so as to generate the images corresponding to the video signal input. It should be noted that since the display drivers 3R, 3G, and 3B are equivalent to those in a circuit of a typical three-plate type liquid crystal projector.

The light source driver 4 is a driver for supplying the first light source section 101 and the second light source section 102 with the drive current to thereby drive the first light source section 101 and the second light source section 102. The light source driver 4 has a control section 5, a RAM 6, and a register 7.

In the present embodiment, the light source driver 4 performs the PWM control on the drive currents respectively supplied to the first light source 20 and the second light source 10 to thereby drive the first light source 20 and the second light source 10. In other words, the light source driver 4 controls the two light sources with a single driver.

The control section 5 controls the first light source section 101 (the first light source 20), the second light source section 102 (the second light source 10), the RAM 6, and the register 7 in accordance with commands from the main control section 2. The details of the operation of the control section 5 will be described later. The control section 5 is formed of, for example, a CPU. The RAM 6 is formed of a memory for rewritably holding light emission information related to the first light source section 101 and the second light source section 102 calculated by the control section 5. The register 7 functions as a storage section for storing the light emission information transmitted from the RAM 6.

Next, the operation of the projector 1 according to the present embodiment will be described.

The method of driving the projector 1 according to the present embodiment has an information acquisition step for obtaining the information related to the brightness of the image information, and a drive step for driving the first light source section 101 and the second light source section 102 based on the information related to the brightness of the image information thus obtained.

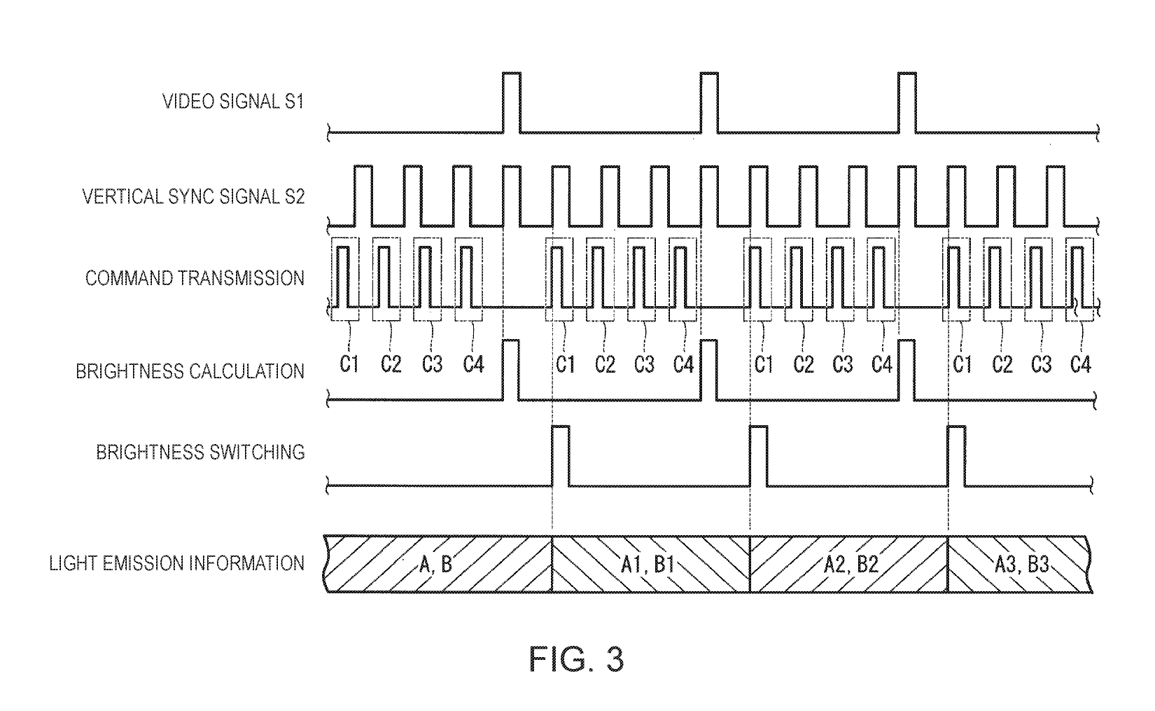

FIG. 3 is a timing chart for explaining the operation of the projector 1. FIG. 3 corresponds to a timing chart for controlling the brightness in the projector 1. In FIG. 3, the horizontal axis represents time, and there are shown the video signal S1 input to the main control section 2, a vertical sync signal S2 output from the main control section 2 to the light source driver 4, timings for performing command transmission from the main control section 2 to the light source driver 4, brightness calculation by the light source driver 4, and brightness switching (brightness control) by the light source driver 4, respectively. Further, there is shown the drive condition (the light emission information) in the first light source section 101 and the second light source section 102 due to the brightness control.

The period of the pulse of the video signal S1 shown in FIG. 3 represents the frame frequency of the video signal S1. In the present embodiment, the frame frequency of the video signal S1 is set to, for example, 24 through 60 Hz. The vertical sync signal S2 output to the light source driver 4 is for defining the timing for displaying the image corresponding to the image information in the image forming areas of the respective liquid crystal light modulation devices 400R, 400G, and 400B in one frame period of the video signal S1, and is set to an integral multiple of the frame frequency of the video signal S1, for example, 96 through 960 Hz.

The main control section 2 obtains the information (e.g., luminance information) related to the brightness of the image information (the video signal) to be input to the projector 1 as the information acquisition step, and then performs the drive step. In the drive step, the main control section 2 determines whether or not brightness control will be performed. In the case of performing the brightness control, the main control section 2 transmits predetermined commands C1, C2, C3, and C4 to the light source driver 4.

In the projector 1 according to the present embodiment controls the brightness (luminance) of the first light source 20 and the second light source 10 using at least one of a method of controlling the current value of the drive current and a method of controlling the pulse width (the duty ratio) of the PWM control. Thus, it is possible to easily realizing the brightness control of the first light source 20 and the second light source 10.

As shown in FIG. 3, in the commands C transmitted from the main control section 2 to the light source driver 4, the command C1 relates to setting of the current value of the drive current supplied to the first light source 20, the command C2 relates to setting of the current value of the drive current supplied to the second light source 10, the command C3 relates to setting of the pulse width (the duty ratio) of the PWM control of the drive current supplied to the first light source 20, and the command C4 relates to setting of pulse width (the duty ratio) of the PWM control of the drive current supplied to the second light source 10.

The light source driver 4 receives the commands C1 through C4, and in the case in which the commands C1 through C4 have normally been received, the light source driver 4 transmits a receive command to the main control section 2. Then, the light source driver 4 calculates first light emission information A, A1 through A3 related to the light emission of the first light source section 101, and second light emission information B, B1 through B3 related to the light emission of the second light source section 102. The calculation of the light emission information is performed by, for example, the control section 5.

In the present embodiment, the first light emission information A, A1 through A3 and the second light emission information B, B1 through B3 correspond to the drive condition of the first light source section 101 and the second light source section 102 for performing the brightness control. Specifically, the first light emission information A, A1 through A3 includes the current value of the drive current of the first light source 20 and the pulse width of the PWM control, and the second light emission information B, B1 through B3 includes the current value of the drive current of the second light source 10 and the pulse width of the PWM control. It should be noted that it is sufficient for the first light emission information A, A1 through A3 and the second light emission information B, B1 through B3 to include at least one of the current value of the drive current and the pulse width of the PWM control as described above.

In FIG. 3, each of the pulses in the brightness calculation represents the timing for the control section 5 to calculate the light emission information. The timing for the brightness calculation is set behind the timing at which the light source driver 4 has received all of the commands C1 through C4 transmitted from the main control section 2. The first light emission information A, A1 through A3 and the second light emission information B, B1 through B3 having been calculated are stored in the RAM 6 of the light source driver 4.

Subsequently, the light source driver 4 changes the brightness of the first light source section 101 and the second light source section 102 to thereby perform the brightness control. The timing for performing the brightness control will be described later.

In FIG. 3, each of the pulses in the brightness switching represents the timing for the light source driver 4 to vary the brightness of the light emission of the first light source section 101 (the first light source 20) and the second light source section 102 (the second light source 10). As shown in FIG. 3, after the brightness calculation has been performed, the light source driver 4 makes the first light source section 101 (the first light source 20) emit the light based on the first light emission information A, A1 through A3 thus calculated, and at the same time makes the second light source section 102 (the second light source 10) emit the light based on the second light emission information B, B1 through B3 to thereby perform the brightness control. In other words, the light source driver 4 determines the first light emission information A, A1 through A3 related to the light emission of the first light source section 101 and the second light emission information B, B1 through B3 related to the light emission of the second light source section 102, and then makes the first light source section 101 (the first light source 20) emit the light based on the first light emission information A, A1 through A3, and at the same time makes the second light source section 102 (the second light source 10) emit the light based on the second light emission information B, B1 through B3.

The light source driver 4 transmits the first light emission information A, A1 through A3 and the second light emission information B, B1 through B3 having been written in the RAM 6 to the register 7 using DMA (direct memory access). The light source driver 4 makes the first light source section 101 (the first light source 20) and the second light source section 102 (the second light source 10) emit the light (drives the first light source section 101 (the first light source 20) and the second light source section 102 (the second light source 10)) based on the first light emission information A, A1 through A3 and the second light emission information B, B1 through B3 transmitted to the register 7.

Specifically, the brightness control (switching of the brightness) is performed in the light source driver 4 at the timing at which the first light emission information A, A1 through A3 and the second light emission information B, B1 through B3 having been written in the RAM 6 is transmitted to the register 7 using DMA. Therefore, the brightness of the first light source section 101 (the first light source 20) and the brightness of the second light source section 102 (the second light source 10) are switched at the same time.

In the present embodiment, the light source driver 4 transmits the information written in the RAM 6 to the register 7 using DMA in sync with the input timing of the vertical sync signal S2 irrespective of the transmission of the commands C1 through C4 from the main control section 2. Therefore, the first light source 20 and the second light source 10 are driven based on the light emission information, which has been transmitted to the register 7 in the latest brightness control, unless the subsequent brightness control is performed. As shown in FIG. 3, the first light source 20 and the second light source 10 are driven based on the first light emission information A and the second light emission information B until the next brightness control is performed.

For example, in FIG. 3, there is shown the case in which the brightness control is performed three times, and as a result, every time the brightness control is performed, there occurs the change to the first light emission information A1 and the second light emission information B1, the first light emission information A2 and the second light emission information B2, and the first light emission information A3 and the second light emission information B3 in sequence.

Further, the brightness control is controlled by the light source driver 4 so as to be performed at a predetermined timing after the brightness calculation. Specifically, in the case of varying the brightness of light emission of the first light source section 101 (the first light source 20) and the brightness of light emission of the second light source section 102 (the second light source 10), the light source driver 4 determines the first light emission information A, A1 through A3 related to the light emission of the first light source section 101 and the second light emission information B, B1 through B3 related to the light emission of the second light source section 102, and then makes the first light source section 101 (the first light source 20) emit the light based on the first light emission information A, A1 through A3, and at the same time makes the second light source section 102 (the second light source 10) emit the light based on the second light emission information B, B1 through B3 at a predetermined timing.

The predetermined timing at which the brightness switching is performed is sync with the vertical sync signal S2 as shown in FIG. 3. In other words, the predetermined timing is the timing at which the vertical sync signal S2 is output to each of the liquid crystal light modulation devices 400R, 400G, and 400B.

Thus, since the brightness control is performed after the brightness of the light emission of both of the first light source section 101 and the second light source section 102 is determined, there is no chance that the brightness control is performed in the state in which only the brightness of the light emission of either one of the first light source section 101 and the second light source section 102 is determined, and therefore, it is possible to perform the brightness control of the first light source section 101 and the brightness control of the second light source section 102 at the same time. Therefore, it is possible to prevent the disturbance of the color balance in the projection image projected by the projector 1 from occurring to thereby prevent flickers in the projection image.

Further, since the brightness control is performed at the timing at which the vertical sync signal S2 is output to each of the liquid crystal light modulation devices 400R, 400G, and 400B as the predetermined timing, there is no chance that the brightness control is performed while writing the frame image into the image forming area of each of the liquid crystal light modulation devices 400R, 400G, and 400B, and it is possible to perform the brightness control at the timing at which the writing of the frame image into the image forming area of each of the liquid crystal light modulation devices 400R, 400G, and 400B is started, and it is possible to prevent the flickers in the projection image projected by the projector 1.

Further, the light source driver 4 performs the brightness calculation described above in sync with the input timing of the vertical sync signal S2.

In the case in which the brightness calculation is performed out of sync with the input timing of the vertical sync signal S2, there is a possibility that the DMA transmission described above starts in sync with the vertical sync signal S2 input in the process of the brightness calculation. In this case, there is a possibility that a part of the first light emission information A, A1 through A3 and the second light emission information B, B1 through B3 is not transmitted to the register 7, and thus, the correct brightness control cannot be performed. According to the present embodiment, the problem described above is solved by performing the brightness calculation in sync with the input timing of the vertical sync signal S2.

As described hereinabove, according to the projector 1 of the present embodiment, since the brightness of the first light source section 101 (the first light source 20) and the brightness of the second light source section 102 (the second light source 10) are switched at once with the single light source driver 4, it is possible to perform the brightness control without causing the disturbance in the white balance (color balance) of the white light W.

Further, since the brightness control is performed in sync with the timing (the input timing of the vertical sync signal S2) of making each of the liquid crystal light modulation devices 400R, 400G, and 400B display the image, it is possible to reduce the chance that the flickers occur in the image projected on the screen SCR.

The invention is not limited to the contents of the embodiment described above, but can arbitrarily be modified within the scope or the spirit of the invention.

For example, in the projector 1 according to the embodiment described above, there is described the case in which the blue light BL from the first light source section 101 and the fluorescence Y from the second light source section 102 are separated in the red light LR, the green light LG, and the blue light LB to thereby make the red light LR, the green light LG, and the blue light LB enter the liquid crystal light modulation devices 400R, 400G, and 400B, respectively, but the invention is not limited to this case.

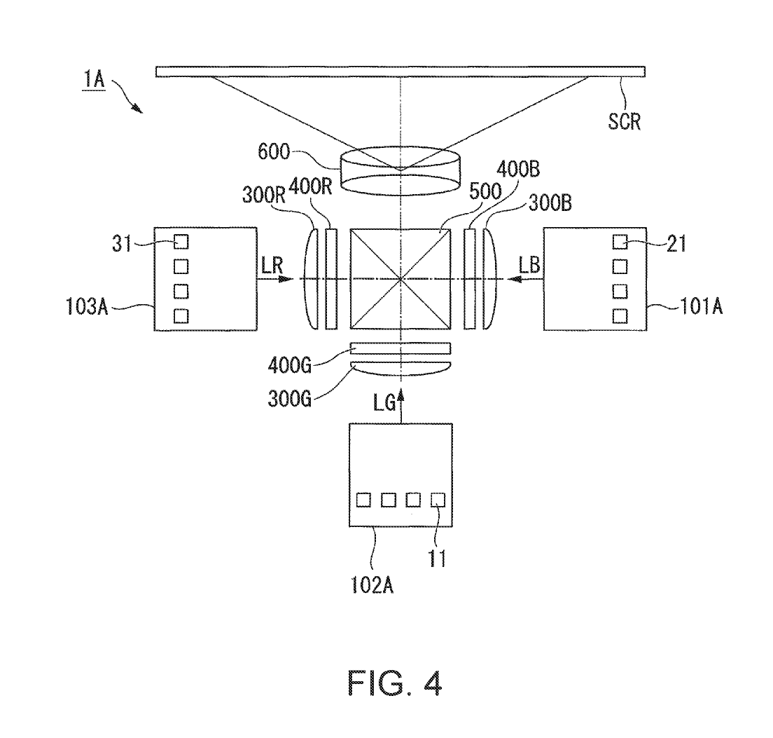

FIG. 4 is a diagram showing a projector 1A according to a modified example.

As shown in FIG. 4, the projector 1A is provided with three light source sections, namely first light source section 101A for emitting the blue light LB, a second light source section 102A for emitting the green light LG, and a third light source section 103A for emitting the red light LR, and the three liquid crystal light modulation devices 400B, 400G, and 400R corresponding to the respective light source sections.

In this modified example, the first light source section 101A, the second light source section 102A, and the third light source section 103A are different from each other in wavelength of the light emitted therefrom.

More specifically, the first light source section 101A includes a plurality of semiconductor lasers (a first light emitting element group) 21 for emitting the blue light LB with a first wavelength in the wavelength band of 430 nm through 480 nm. The second light source section 102A includes a plurality of semiconductor lasers (a third light emitting element group) 11 for emitting the green light LG with a third wavelength in the wavelength band of 480 nm through 520 nm different from the first wavelength. The third light source section 103A emits the red light with a fourth wavelength in the wavelength band of 620 nm through 810 nm.

The blue light LB, the green light LG, and the red light LR emitted from the light source sections 101A, 102A, and 103A enter the liquid crystal light modulation devices 400B, 400G, and 400R, respectively.

It should be noted that it is also possible to arrange that the first light source section 101A emits the green light LG as the light with a first wavelength, the second light source section 102A emits the red light LR as the light with a third wavelength, and the third light source section 103A emits the blue light LB as the light with a fourth wavelength. In other words, in the projector provided with three light emitting element groups (light source sections) for respectively emitting light different in wavelength band from each other, and the three liquid crystal light modulation devices 400R, 400G, 400B corresponding to the light in the respective wavelength bands, a variety of combinations can be adopted.

Further, as another modified example, it is possible to adopt a projector provided with, for example, a first light source section for emitting the red light, and a second light source section for emitting the green light and the blue light. More specifically, it is also possible to arrange that the first light source section includes a first light emitting element group for emitting the light with a first wavelength in the wavelength band of 620 nm through 810 nm, and the second light source section includes a third light emitting element group for emitting the light with a third wavelength in the wavelength band of 430 nm through 480 nm different from the first wavelength, and a wavelength conversion element for converting a part of the light with the third wavelength into the light with a fourth wavelength in the wavelength band of 480 nm through 520 nm. In the projector provided with two light emitting element groups (light source sections) for respectively emitting light different in wavelength band from each other, and the wavelength conversion element for converting a part of one of the light in the two wavelength bands into light in still another wavelength band as described above, a variety of combinations can be adopted.

Further, although in the embodiment described above, there is illustrated the projector 1 provided with the three liquid crystal light modulation devices 400R, 400G, and 400B, the invention can also be applied to a projector for displaying a color picture with a single liquid crystal light modulation device. Further, a digital mirror device can also be used as the light modulation device.

Further, although in the embodiment described above, there is described the example of installing the illumination device according to the invention in the projector, the invention is not limited to this example. The illumination device according to the invention can also be applied to lighting equipment, a headlight of a vehicle, and so on.

The entire disclosure of Japanese Patent Application No. 2017-015644, filed Jan. 31, 2017 is expressly incorporated by reference herein.

What is claimed is:

1. A projector comprising:
a plurality of light source sections configured to emit light respectively;
a light modulation device configured to modulate the light emitted from the plurality of light source sections in accordance with image information;
a projection optical system configured to project the light modulated by the light modulation device; and
a drive section configured to drive the plurality of light source sections,
wherein the plurality of light source sections includes a first light source section and a second light source section different from each other in wavelength of the light emitted, and
wherein in a case of varying brightness of light emission of the first light source section and the second light source section, the drive section is configured to
determine first light emission information with respect to light emission of the first light source section and second light emission information with respect to light emission of the second light source section, and
then, at a predetermined timing, adjust the light emission of the first light source section based on the first light emission information and adjust the light emission of the second light source section based on the second light emission information.

2. The projector according to claim 1,
wherein the drive section, at a timing at which a vertical sync signal is output to the light modulation device as the predetermined timing, adjusts the light emission of the first light source section based on the first light emission information and adjusts the light emission of the second light source section based on the second light emission information.

3. The projector according to claim 1,
wherein the drive section drives the first light source section and the second light source section with pulse width modulation control of a drive current respectively supplied to the first light source section and the second light source section, and
wherein the first light emission information and the second light emission information each include at least one of a current value of the drive current and a pulse width of the pulse width modulation control.

4. The projector according to claim 1,
wherein the first light source section includes a first light emitting element group configured to emit the light with a first wavelength, and
wherein the second light source section includes
a second light emitting element group configured to emit the light with the first wavelength, and
a light wavelength conversion element configured to convert a wavelength of the light emitted from the second light emitting element group from the first wavelength into a second wavelength different from the first wavelength.

5. The projector according to claim 4,
wherein the light with the first wavelength is light in a wavelength band of 430 nm through 480 nm, and
wherein the light with the second wavelength is light in a wavelength band of 520 nm through 580 nm.

6. The projector according to claim 1,
wherein the first light source section includes a first light emitting element group configured to emit the light with a first wavelength, and
wherein the second light source section includes a third light emitting element group configured to emit the light with a third wavelength different from the first wavelength.

7. The projector according to claim 6,
wherein the light with the first wavelength is light in one wavelength band of 430 nm through 480 nm, 480 nm through 520 nm, and 620 nm through 810 nm, and
wherein the light with the third wavelength is light in one wavelength band of remaining two wavelength bands.

8. The projector according to claim 1,
wherein the drive section is a single drive section, and
wherein the single drive section drives the first light source section and the second light source section different from each other in wavelength of the light emitted.

9. A method of controlling a projector provided with a plurality of light source sections including a first light source section and a second light source section different from each other in wavelength of light emitted, and a light modulation device configured to modulate the light from the plurality of light source sections in accordance with image information, the method comprising:
obtaining information with respect to brightness of the image information;
driving the plurality of light source sections based on the obtained information with respect to the brightness of the image information; and
in a case of varying brightness of light emission of the first light source section and the second light source section,
determining first light emission information with respect to light emission of the first light source section and second light emission information with respect to light emission of the second light source section, and
then, at a predetermined timing, adjusting the light emission of the first light source section based on the first light emission information and adjusting the light emission of the second light source section based on the second light emission information.
